(19) United States
(12) Patent Application Publication
(10) Pub. No.: US 2005/0151286 A1
(43) Pub. Date: Jul. 14, 2005

(54) Gradient refrective-index plastic rod and method for making the same

(75) Inventor: Jui-Hsiang Liu, Tainan City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: NATIONAL CHENG KUNG UNIVERSITY, Tainan City (TW)

(21) Appl. No.: 11/008,658

(22) Filed: Dec. 10, 2004

(30) Foreign Application Priority Data
Dec. 11, 2003 (TW) 92135091

(51) Int. Cl. G02B 6/02

(52) U.S. Cl. 264/1.38

(57) ABSTRACT

A gradient refractive-index (GRIN) plastic rod comprises a monomer, a surfactant monomer (surfmer), and nanoparticles. The surfmer, which keeps nanoparticles and polymers in a good mutual solubility, can increase a content of nanoparticles, and thus overcome a problem of the resulting opaque plastic rod caused by introducing nanoparticles in the prior art. Moreover, nanoparticles can increase a difference of refractive index, the numerical aperture and a transmission efficiency of the GRIN plastic rod.

### CROSS-REFERENCE TO RELATED APPLICATION

This application claims the priority benefit of Taiwan application serial no. 92135091, filed Dec. 11, 2003, the full disclosure of which is incorporated herein by reference.

### FIELD OF THE INVENTION

The present invention relates to a gradient refractive-index (GRIN) plastic rod and a method for making the same, and more particularly, to a GRIN plastic rod containing nanoparticles and a method for making the same. In addition, the present invention further relates to a method for making a GRIN plastic rod, and more particularly, to a GRIN plastic rod containing nanoparticles by using a polymerizable surfactant monomer (surfmer).

### BACKGROUND OF THE INVENTION

Optical rods are designed to be a medium for transmitting light signal in light communication system, and developed from a discovery of ruby laser in 1960. Conventionally, the classification of the optical rods are divided into three kinds: quartz or plastics according to the material of the plastic rod itself; step index (SI) or gradient index (GI) according to the distribution of refractive index; and single-mode or multi-mode according to transmitted light energy distribution, wherein the mode relates to the caliber size, the larger caliber size belongs to the multi-mode for transmitting multiple sets of light beams. The plastic optical fiber (POF) belongs to the multi-mode due to its larger caliber and volume (milli-scale). The quartz optical fiber can be drawn to achieve micro-scale, so it belongs to single-mode or multi-mode.

The POF has lots of advantages such as softness, light weight, easy coupling, large caliber and volume. As such for the plastic material, although it is more than the inorganic material such as quartz in light absorption (especially in the spectra of infrared and visible light), many organic materials have very good transparency, so as to be suitable for transmitting the visible light. Moreover, the parameters of the POF are designed flexibly, especially for a light focusing rod (LFR) that has less length and is less affected by the optical loss.

The LFR is a kind of a gradient refractive-index (GRIN) plastic rod that has parabolic refractive index distribution decreasing continuously from the optical axis to the periphery. Such a special refractive index distribution keeps the incident light to progress along a meandering path, resulting in an assembling phenomenon occurring at the space behind its emitting end. The GRIN plastic rod has the same function with the convex, so it is generally called the “LFR”.

The GRIN plastic rod is mainly applied in the image transmission, for example, lens array, and also applied in the image transmission elements, for example, the facsimile machines and small copiers. Additionally, other devices, for example, the sensors, connection devices between the optical fibers, the pick-up heads for the laser disc, the light-focusing lens, integrated optical elements and so on, have occupied most market. Furthermore, the GRIN plastic rod is unfavorable to the long-distance communication, but it has advantages such as low production cost, good flexibility, large caliber, excellent processing, the ends easily handled and connected, and convenience for on-site operation. Therefore, these advantages give more freedom to design the light-transmission system, and expand the application field, especially suitable for the information-transmission system with short-distance and multiple connections, for example, local area network (LAN).

In Nature, the mirage is the most significant example with respect to the image-transmission phenomenon of GRIN, and is firstly studied through the literature on the topic. Theoretical research was made in 1854 by Maxwell who gave an equation of GRIN optics-Maxwell fisheye lens. Until 1895, Schott produced the GRIN glass rod by using various cooling rates. After ten years, R. W. Wood, who used gelatin to produce the sheet-like light-focusing lens (also to be divergent lens, depending on the refractive index distribution), pioneered in production of the organic GRIN optical rod.

At present, there are many research reports and patents with respect to the material of the optical fiber and the method for making the same. However, the most research is limited in the quartz, but the research in the plastic lens is less. The known manufacturing technologies of the plastic lens include the technology for manufacturing the plastic lens with multiple components, the photo-copolymerization for manufacturing the convex lens, the concave lens, W-shaped and reverse W-shaped lens, and the copolymerization for manufacturing the plastic rods having various refractive index distributions by using the interface adhesive. In addition, two methods provided by Japan Mitsubishi Chemical Cooperation overcome the problem of the conventional batch-type production of GI lens in the manner of continuously pressing and evaporating production.

In summary, the methods for manufacturing various GI optical elements can be generalized as follows: swelling and permeating method, photo-copolymerization, two-staged copolymerization of permeating in liquid phase, two-staged copolymerization of permeating in gaseous phase, copolymerization with the interface adhesive, centrifugal casting method, evaporating copolymerization and so on. Among those, the methods of permeating in gaseous or liquid phase and ultraviolet (UV) photo-copolymerization are the most popular. In the former one, bridge monomers must be prepolymerized a gel-like rod, other monomers are utilized in permeating procedure, and permeating time and temperature control the refractive index distribution of the optical rod. The resultant optical rod, due to having network-like structure, can not be drawn to thin fibers, so it has many limitations in further application. Besides, the prepolymerized gel structure is very tight, monomers are frequently polymerized and accumulated on the outer layer during permeating, resulting in the distorted image transmission. Moreover, the process expends much time, so the permeating method is unfavorable to the optical rod with large caliber. In the later one, the UV light energy is decreased from the glass tube wall toward the central axis, and various ratios of the monomers react, so that the polymer gradually grows from the tube wall to the central axis, resulting in the distribution of the refractive index in curves. This method utilizes non-bridge monomers to copolymerize a linear polymer, and only one step is required, however, phase separation often occurs during polymerization. Hence, only the central clear region can act as the image transmission area. Consequently, this method is also unfavorable to manufacture the optical rod with large caliber.

The inventor of the present invention has disclosed a process for fabricating a gradient refractive-index plastic rod using polymerization method in TW Patent No. 335,432 (see also in U.S. Pat. No. 6,136,234). The GRIN plastic rod is prepared by filling a composition containing at least one monomer into a preformed body, swelling this preformed body containing the monomer composition at a constant temperature, and polymerizing the monomer composition. Therefore, the resultant plastic rod can be produced in the batch type or continuous type.

Typically, the refractive index of the organic polymer is less than 1.6, but the one of the inorganic polymer is more than 1.6. If inorganic nanoparticles are introduced into the organic material, the whole refractive index and the numerical aperture (NA) will be increased. Due to the nano-scale material having the specific structure, many special effects occur, such as small-size effect, quantum-size effect, surface effect and macroscopic quantum channel. The nano-scale material shows optical, electric, thermal, magnetic, absorptive, reflective, adsorptive, catalytic and biological properties that are different from the bulk material. Therefore, the nano-scale material plays an important role on electronics, materials, communication and biotechnology.

However, when the nanoparticles are introduced into the plastic rod, due to their bad mutual solubility and the limitation to the surfactant existing on process, the excess nanoparticles leads the plastic rod to be opaque. Hence, there is an urgent need to provide a method for making a GRIN plastic rod, so as to overcome the problem of the resulting opaque plastic rod caused by introducing nanoparticles, and to enhance the whole refractive index and the NA value.

### SUMMARY OF THE INVENTION

It is an aspect of the present invention to provide a method for making a GRIN plastic rod. A surfactant monomer (surfmer) of the present invention is added to introduce nanoparticles into a plastic rod. An oil-phase (hydrophobic) portion of the surfactant can participate a polymerization of organic polymers, and a water-phase (hydrophilic) portion thereof can increase an amount of the nanoparticles, so as to keep nanoparticles and polymers in a good mutual solubility. Therefore, a problem of the resulting opaque plastic rod caused by introducing nanoparticles can be successfully overcome.

It is another aspect of the present invention to provide a method for making a GRIN plastic rod. The GRIN plastic rod contains nanoparticles that can increase a difference of refractive index and a NA value greatly, so as to promote an image transmitting efficiency significantly.

According to the aforementioned aspect of the present invention, a composition suitable for forming a GRIN plastic rod is provided, which comprises at least one monomer, at least one surfmer and nanoparticles, wherein the monomer is a compound having formulas (I) to (VI) shown as follows: 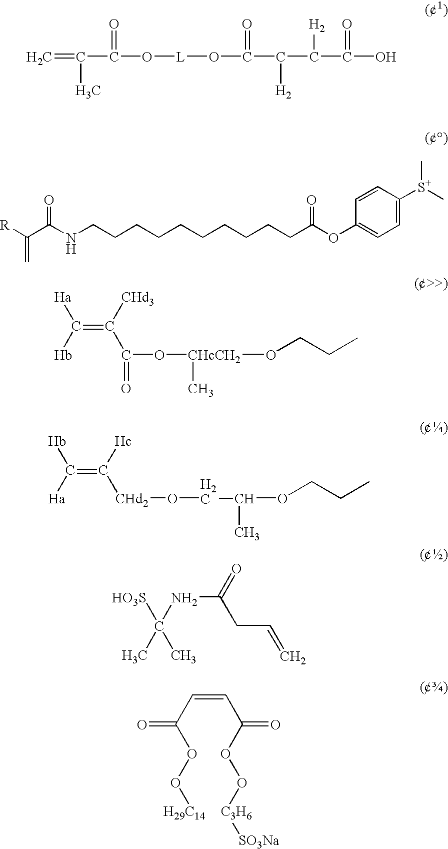
wherein L is a C₂-C₂₀ alkylene group, and R is hydrogen atom or methyl group.

In a preferred embodiment of the present invention, the monomer may be, for example, methyl methacrylate (MMA), benzyl methacrylate (BzMA), tetrafluoropyl methacrylate, tetrafluoropyl methacrylate, diphenyl sulfide (DS), bromonaphthalene (BN), benzyl salicylate (BSA), 1,4-dibromobenzene, triphenyl phosphate (TPP) or any combination thereof.

In a preferred embodiment of the present invention, the nanoparticles may be, for example, surfmer-stabilized metal nanoparticles, organic polymer nanoparticles or coupler-stabilized metal oxide nanoparticles.

According to the aforementioned aspect of the present invention, a method for making a GRIN plastic rod is further provided. A mixing solution having at least one monomer, at least one surfmer and nanoparticles is firstly provided. Next, a pre-polymerization is performed, wherein after the mixing solution poured into a glass tube, a initiator is added into the mixing solution, and the monomer and the surfmer are prepolymerized to a prepolymer by a centrifugation. Then, a diffusing polymerization is performed by heating the prepolymer to form the GRIN plastic rod.

In a preferred embodiment of the present invention, a method of making the nanoparticles comprises the following steps. A plurality of reverse micellar systems are firstly formed, wherein two solutions are respectively added into another mixing solution containing the surfmer and the monomer at 25° C., and each of the two solutions and the mixing solution are in a weight ratio of 1/1, whereby forming the reverse micellar systems. Next, a redox reaction is performed, wherein the reverse micellar systems collide, diffuse and reagglutinate with each other, for keeping the two solutions to be subjected to the redox reaction in the reverse micellar systems, whereby forming the mixing solution containing the nanoparticles.

In a preferred embodiment of the present invention, the monomer is a compound having formulas (I) to (VI) shown as above, wherein L is a C₂-C₂₀ alkylene group, and R is hydrogen atom or methyl group.

In a preferred embodiment of the present invention, the nanoparticles may be, for example, surfmer-stabilized metal nanoparticles, organic polymer nanoparticles or coupler-stabilized metal oxide nanoparticles.

In a preferred embodiment of the present invention, the monomer may be, for example, MMA, BzMA, tetrafluoropyl methacrylate, tetrafluoropyl methacrylate, DS, BN, BSA, 1,4-dibromobenzene, TPP or any combination thereof.

According to the aforementioned aspect of the present invention, a method for making a GRIN plastic rod is still provided. A mixing solution having at least one monomer, at least one surfmer and nanoparticles is firstly provided. Next, a swelling reaction is performed, wherein the mixing solution is poured into a plastic tube and reacted for a predetermined time, for prepolymerizing the monomer and the surfmer to a prepolymer. Then, a polymerization is performed by heating the prepolymer in the plastic tube to form the GRIN plastic rod.

According to the aforementioned aspect of the present invention, a method for making a GRIN plastic rod is still further provided. A mixing solution having at least one monomer, at least one surfmer and nanoparticles is firstly provided. Next, a multiplayer co-extruding process is performed, which utilizes a plurality of multiplayer extruding pipes with different calibers covered concentrically, so as to keep concentrations of the monomer and the nanoparticles in the mixing solution decreased progressively from a center to an outside, and while co-extruding the multiplayer extruding pipes, an ultra-violet light is irradiated to the mixing solution at an outlet for carrying out a polymerization, whereby forming the GRIN plastic rod.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a co-extruding polymerization apparatus according to a preferred embodiment of the present invention;

FIG. 2 depicts a refractive index distribution of the resultant GRIN plastic rod according to a preferred embodiment of the present invention; and

FIG. 3 shows an image picture transmitted through the GRIN plastic rod according to a preferred embodiment of the present invention.

### DETAILED DESCRIPTION OF THE PREFERRED EMBODIMENT

The present invention provides a method for making a GRIN plastic rod, which adds a surfmer of the present invention for introducing nanoparticles with high refractive index into a GRIN plastic rod produced by plastic monomers with low refractive index, wherein an oil-phase (hydrophobic) portion of the surfactant can participate a polymerization of organic polymers, and a water-phase (hydrophilic) portion thereof can increase an amount of the nanoparticles, so as to keep nanoparticles and polymers in a good mutual solubility and to overcome a problem of the opaque plastic rod resulting from phase separation caused by introducing nanoparticles. Therefore, a difference of refractive index is increased, so as to increase a NA value.

A composition suitable for forming a GRIN plastic rod comprises at least one monomer, at least one surfmer and nanoparticles, wherein the surfmer can be a compounds of any commercial polymerizable surfmer product, or the one having formulas (I) to (VI) shown as follows: 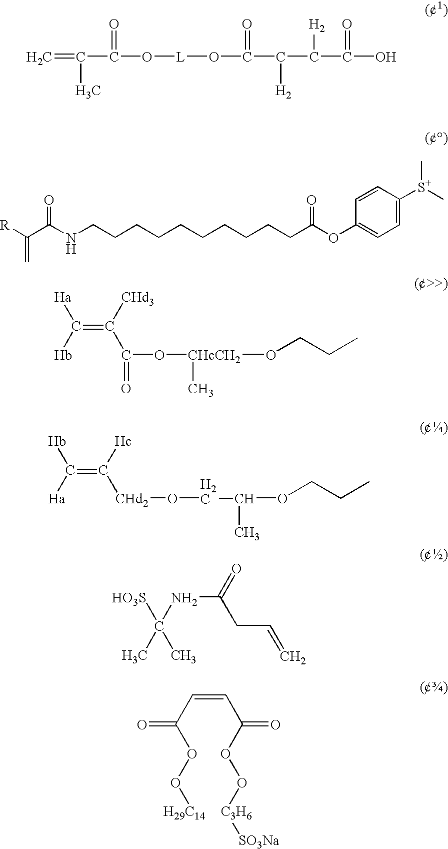
wherein L is a C₂-C₂₀ alkylene group, and R is hydrogen atom or methyl group. For example, if the L of the surfmer (I) is a C₂ alkylene group, the surfmer can be 2-methacryloyloxyethyl succinate (MAES). If the L of the surfmer (I) is a C₁₁ alkylene group, the surfmer can be succinic acid mono-{11-[2-(2-methyl-acryloyloxy)-ethoxy]-undecyl})ester (SAME-11). If the R of the surfmer (II) is a hydrogen atom, the surfmer can be p[11-(acrylamido)-undecanoyloxy]phenyldimethylsulfonium methylsulfate (AUPDS). If the R of the surfmer (II) is a methyl group, the surfmer can be p[11-(methacrylamido)-undecanoyloxy]phenyldimethylsulfonium methylsulfate (MUPDS). In addition, if the commercial polymerizable surfmer product is applied in the present invention, the surfmer can be sodium bis(2-ethylhexyl)sulfosuccinate (AOT), methacrylic surfmer (Mac) (III), allylic surfmer (All) (IV), 2-acryloylamido-2-methylpropanesulfonic acid, and sodium tetradecyl 3-sulfopropyl maleate. It is worth mentioning that the present invention can use the same surfmer or a mixture of different ones.

In a preferred embodiment of the present invention, the monomer may be, for example, methyl methacrylate (MMA), benzyl methacrylate (BzMA), tetrafluoropyl methacrylate, tetrafluoropyl methacrylate, diphenyl sulfide (DS), bromonaphthalene (BN), benzyl salicylate (BSA), 1,4-dibromobenzene, triphenyl phosphate (TPP) or any combination thereof.

Reference is made to TAB. 1, which depicts the monomer and a refractive index of its polymer formed thereof in accordance with a preferred embodiment of the present invention:

TABLE 1

| Monomer | Refractive Index of the Polymer |
|---|---|
| MMA | 1.49 |
| BzMA | 1.568 |
| Tetrafluoropyl Methacrylate | 1.42 |
| DS | 1.63 |
| BN | 1.66 |
| BSA | 1.58 |
| 1,4-Dibromobenzene | 1.574 |
| TPP | 1.55 |

The foregoing examples of the compositions of the monomer are merely offered for the purpose of illustrating the content of the present invention, rather than intending to limit the scope of the present invention, and the monomer can be any monomer in the prior art for synthesizing the plastic rod. For example, the monomer can be a mixture of MMA and DS, MMA and BzMA, or MMA and BN. If the monomer is a mixture of MMA and DS, MMA and DS are preferred in a ratio of 2/1 to 5/1 by weight. If the monomer is a mixture of MMA and BzMA, MMA and BzMA are preferred in a ratio of 3/1 by weight. If the monomer is a mixture of MMA and BN, MMA and BN are preferred in a ratio of 3/1 to 4/1 by weight.

The surfmer of the present invention can be any commercial polymerizable surfmer product, or the one having formulas (I) to (VI) shown as above. The surfmer is not given unnecessary details due to being discussed above.

In a preferred embodiment of the present invention, the nanoparticles may be, for example, surfmer-stabilized metal nanoparticles, organic polymer nanoparticles or coupler-stabilized metal oxide nanoparticles. Besides, an amount of the nanoparticles in the composition of the GRIN plastic rod is in a range of 1×10⁻⁵ to 2×10⁻³ percent by mole, for example.

According to the foregoing description, the present invention further discloses a method for making a GRIN plastic rod by using the above composition. A mixing solution having at least one monomer, at least one surfmer and nanoparticles is firstly provided. In a preferred embodiment of the present invention, the monomer, the surfmer and the nanoparticles are not given unnecessary details due to being described in detail as above. However, the nanoparticles of the present invention can be further produced by the following method. A plurality of reverse micellar systems are firstly formed, wherein two solutions are respectively dropped into another mixing solution containing the surfmer and the monomer by using a micropipette at 25° C. The two reverse micellar systems are formed from any of the two solutions and the surfmer, respectively, wherein each of the two solutions and the mixing solution are in a weight ratio of 1/1. Next, a redox reaction is performed, wherein the reverse micellar systems collide, diffuse and reagglutinate with each other under ultrasonication for 1 hour, so as to keep the two solutions to be subjected to the redox reaction in the reverse micellar systems, whereby forming the mixing solution containing the nanoparticles.

The aforementioned two solutions can be a nitrate solution and a reductant solution. For example, the nitrate solution can be silver nitrate (AgNO₃) solution, and the reductant solution can be sodium borohydride (NaBH₄) solution.

Next, a pre-polymerization is performed, wherein the mixing solution is poured into a glass tube, followed by adding an initiator into the mixing solution, vibrating the initiator and the mixing solution under ultrasonication for 5 minutes, and prepolymerizing the monomer and the surfmer to a prepolymer by a centrifugation.

The size of the above glass tube used in the present invention, depending on the process requirement, for example, is 6 mm in internal diameter, 8 mm in external diameter, and 250 mm in length. Appropriate space remains for sealing the open end in the subsequent process.

The foregoing initiator, such as azobisisobutyronitrile (AIBN), is added into the mixing solution in a percent of 0.1 to 0.5 by weight, and preferably, in a percent of 0.2 by weight.

In a preferred embodiment of the present invention, depending on the process requirement, a prepolymer can be added into the mixing solution, wherein the prepolymer can be, for example, poly-MMA (PMMA). PMMA, which is added into the prepolymer mixing solution that contains nanoparticles, can alleviate the contracting volume during polymerization. Moreover, when a centrifugation is subsequently employed to perform a prepolymerization, a gel layer formed from PMMA is on the inner well of the glass tube for controlling a polymerizing direction and avoiding bubbling. The addition of PMMA maybe decrease little refractive index, however, inorganic nanoparticles added in the GRIN plastic rod of the present invention can greatly improve the refractive index, so as to significantly reveal the effect of the resultant GRIN plastic rod.

Afterward, a diffusing polymerization is performed by heating the prepolymer at 60° C. to 65° C. for reacting 8 hours to 10 hours, so as to form the GRIN plastic rod. Due to low polymerization rate in the glass tube during the static heating process, a diffusion rate of the monomers is more than their polymerization rate, and the reverse micellar systems that contains nanoparticles in the tube center also diffuse toward the tube wall. Thus, the prepolymer must be continuously treated at 60° C. to 65° C. for 8 hours to 10 hours until it reaches high polymerization degree, the GRIN plastic rod is just formed.

An amount of the nanoparticles in the GRIN plastic rod of the present invention, for example, is in a range of 1×10⁻⁵ to 2×10⁻³ percent by mole.

In addition to such method for making the nanoparticles of the present invention disclosed as above, other nanoparticles such as surfmer-stabilized metal nanoparticles, organic polymer nanoparticles or coupler-stabilized metal oxide nanoparticles, are also suitably applied in the present invention.

The centrifugation is employed to keep the glass tube to rotate horizontally or in a angle of about 1° to 3° to a level, for 1 hour to 5 hours in a rotation rate of 100 rpm to 1000 rpm at 35° C. to 80° C. According to another embodiment of the present invention, the centrifugation is preferably employed to keep the glass tube to rotate horizontally or in a angle of about 1° to 3° to a level, for 1 hour to 3 hours in a rotation rate of 200 rpm to 400 rpm at 55° C. to 60° C.

During the diffusing polymerization of the present invention, the prepolymer reacts for 8 hours to 10 hours at 60° C. to 65° C.

According to the aforementioned description, in addition to applying the diffusing centrifugation in the present invention, a swelling polymerization is also suitable for making the GRIN plastic rod, and the method comprises as the following steps. A mixing solution having at least one monomer, at least one surfmer and nanoparticles is firstly provided, wherein the monomer, the surfmer and nanoparticles are not given unnecessary details due to being discussed above.

Next, a swelling reaction is performed, wherein the mixing solution is poured into a plastic tube like poly-MMA (PMMA) plastic tube, and reacted for a predetermined time, for prepolymerizing the monomer and the surfmer to a prepolymer. In a preferred embodiment of the present invention, the swelling reaction can be performed at 55° C. to 65° C. for the predetermined time in a range of 10 hours to 40 hours.

Thereafter, a polymerization is performed by heating the prepolymer in the plastic tube and reacting at 40° C. to 80° C. for 10 hours to 40 hours, so as to form the GRIN plastic rod.

Based on the aforementioned description, in addition to applying the diffusing centrifugation and the swelling polymerization in the present invention, a multiplayer co-extruding process is further suitable for making the GRIN plastic rod, and the method comprises as the following steps. A mixing solution having at least one monomer, at least one surfmer and nanoparticles is firstly provided, wherein the monomer, the surfmer and nanoparticles are not given unnecessary details due to being discussed above.

And then, a multiplayer co-extruding process is performed by utilizing a plurality of multiplayer extruding pipes with different calibers covered concentrically, so as to keep concentrations of the monomer and the nanoparticles in the mixing solution decreased progressively from a center to an outside, and while co-extruding the multiplayer extruding pipes, an ultraviolet light is irradiated to the mixing solution at the outlet for carrying out a polymerization, and a winding machine is employed to control a winding speed of the GRIN plastic rod, whereby producing the GRIN plastic rod having a smaller caliber.

Hereinafter, the GRIN plastic rod and a method for preparing the same of the present invention are more explicitly clarified in following preferred embodiments. However, the embodiments are merely given to illustrate various applications of the invention rather than to be interpreted as limiting the scope of the appended claims.

### EXAMPLE 1

### Process of Nanoparticles

The present invention utilizes reverse micellar systems to perform the redox reaction for making nanoparticles. A surfmer is dissolved in a monomer solution like MMA solution as an organic phase. AgNO₃ solution acts as a water phase A, and NaBH₄ solution acts as another water phase B.

Next, the water phase A and the water phase B are respectively dropped into the MMA organic phase by using the micropipette at 25° C., and each of the water phase A and the water phase B and the MMA organic phase are in a weight ratio of 1/1. The water phase A and the water phase B with the MMA organic phase, respectively, are formed into reverse micellar systems A and reverse micellar systems B.

Later, the reverse micellar systems A and the reverse micellar systems B are mixed and vibrated under ultrasonication for 1 hour, wherein the reverse micellar systems A and the reverse micellar systems B collide, diffuse and reagglutinate with each other, for happening the redox reaction in the reverse micellar systems, whereby forming the nanoparticles. The clear solution of the reverse micellar systems containing the resultant silver nanoparticles is quantitatively analyzed from UV spectrum. In this result, a specific absorption peak of the silver nanoparticles can be observed in about 410 nm.

### EXAMPLE 2

### Centrifugal Diffusing Polymerization Process of Plastic Rod

The process of the plastic rod can use the centrifugal diffusing polymerization. The process is divided into a pre-polymerization stage and a diffusing polymerization stage. The polymerization conditions and the monomer ratios are shown as TAB. 2:

TABLE 2

| Weight Ratio of | | Reaction | Reaction |
|---|---|---|---|
| Monomers | PMMA | Temperature (° C.) | Time (Hour) |
| MMA/DS = 3/1 | 0% | 65 | 2 |
| MMA/DS = 3/1 | 5% | 55 | 3 |
| MMA/DS = 3/1 | 10% | 60 | 1 |
| MMA/DS = 3/1 | 12% | 60 | 2 |
| MMA/DS = 4/1 | 5% | 55 | 3 |
| MMA/DS = 4/1 | 12% | 55 | 2 |
| MMA/BzMA = 3/1 | 5% | 55 | 2 |
| MMA/BN = 3/1 | 5% | 55 | 2 |
| MMA/BN = 4/1 | 5% | 55 | 2 |

0.2 wt. % of AIBN initiator is added into the monomer solution having silver nanoparticles resulted from the reverse micellar systems, under ultrasonication for 5 minutes, and poured into the glass tube with 6 mm in internal diameter, 8 mm in external diameter, and 250 mm in length. Appropriate space remains in the glass tube, and its open end is sealed. Then, the glass is placed in the centrifuge, kept rotating horizontally in a rotation rate of 400 rpm, and prepolymerized at 55° C. for 3 hours. During the pre-polymerization, the polymer gradually attaches to the tube wall, resulting in that the quantity of the polymer accumulating closer to the tube wall is more, and the quantity of the silver nanoparticles and the monomers existing closer to the tube center is more.

Afterward, the glass tube is placed vertically into the 60° C. oven. During the static heating process, the diffusioosmosis rate of the monomers is more than their polymerization rate, so the reverse micellar systems and monomers in the tube center still diffuse toward the tube wall. The heating treatment lasts for 8 hours until the high polymerization degree is achieved. The process of the GRIN plastic rod is completed.

Alternatively, 0.2 wt. % of AIBN initiator is added into the monomer solution having silver nanoparticles resulted from the reverse micellar systems, under ultrasonication for 5 minutes, and poured into the glass tube with 4 mm in internal diameter, 6 mm in external diameter, and 250 mm in length. Appropriate space remains in the glass tube, and its open end is sealed. Then, the glass is placed in the centrifuge, kept rotating in a angle of about 3° to the level, in a rotation rate of 200 rpm, and prepolymerized at 57° C. for 2 hours. During the pre-polymerization, the monomers gradually are polymerized to the polymer on the tube wall during the heating treatment. The quantity of the polymer accumulating closer to the tube wall is more, but the quantity of the monomers accumulating closer thereto is less. On the contrary, the quantity of the silver nanoparticles and the monomers existing closer to the tube center is more, but the quantity of the polymer existing closer thereto is less.

Afterward, the glass tube is placed vertically into the 65° C. oven. During the static heating process, the diffusioosmosis rate of the monomers is more than their polymerization rate, so the monomers in the tube center not only diffuse toward the tube wall, but also are supplied with each other from up to down, so as to fill the gap under centrifugation. The heating treatment lasts for 10 hours until the high polymerization degree is achieved. The process of the GRIN plastic rod is completed.

### EXAMPLE 3

### Swelling Polymerization Process of Plastic Rod

The commercial coupler-stabilized titanium oxide (TiO₂) nanoparticles that contains the surfmer, are mixed with the monomer composition together, and poured into a plastic tube, which is a thick plastic tube such as a PMMA plastic tube with 2 mm in internal diameter and 3 mm in external diameter, or 4 mm in internal diameter and 6 mm in external diameter, for example. The monomer composition, surfmer and nanoparticles are not given unnecessary details due to being discussed above.

Next, a swelling reaction is performed for prepolymerizing the monomer and the surfmer to a prepolymer. In a preferred embodiment of the present invention, the swelling reaction can be performed at 55° C. to 65° C. for the predetermined time in a range of 10 hours to 40 hours.

Later, a polymerization is performed by heating the prepolymer in the plastic tube and reacting at 40° C. to 80° C. for 10 hours to 40 hours, so as to form the GRIN plastic rod.

### EXAMPLE 4

### Co-Extruding Polymerization Process of Plastic Rod

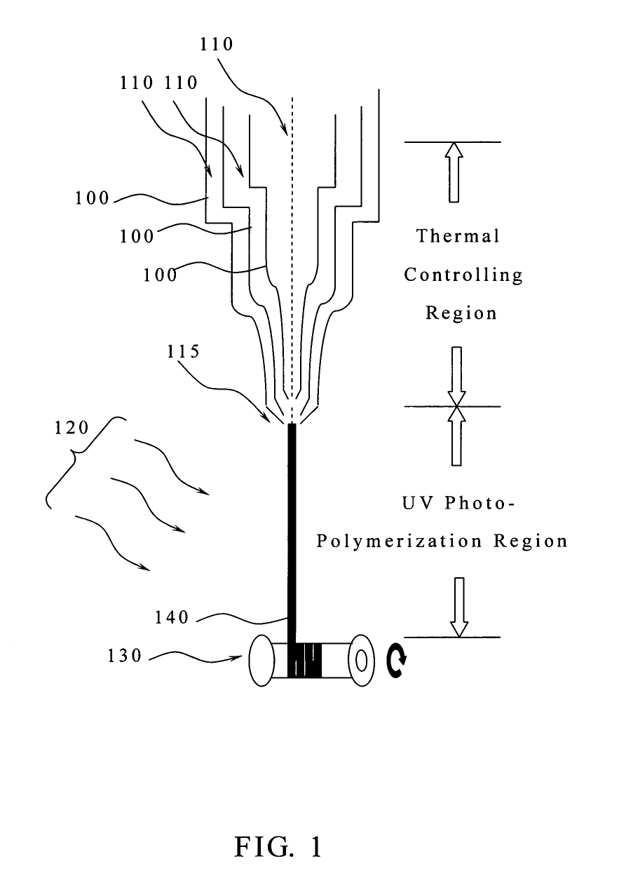

Reference is made to FIG. 1, which depicts a diagram of a co-extruding polymerization apparatus according to a preferred embodiment of the present invention. Multiplayer extruding pipes 100 with different calibers covered concentrically, so as to keep concentrations of the monomer and the nanoparticles in the mixing solution decreased progressively from a center to an outside, and while co-extruding the multiplayer extruding pipes 100, an ultraviolet light 120 is irradiated to the mixing solution at the outlet 115 for carrying out a complete polymerization, and a winding machine 130 is employed to control a winding speed of the GRIN plastic rod 140, whereby producing the GRIN plastic rod 140 having a smaller caliber continuously.

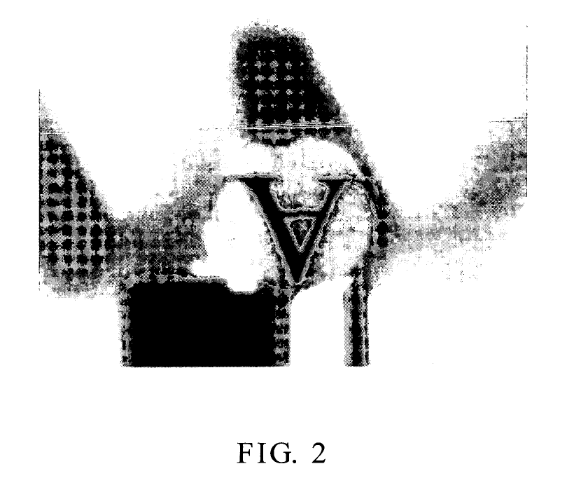

Reference is made to FIG. 2, which depicts a refractive index distribution of the resultant GRIN plastic rod according to a preferred embodiment of the present invention, wherein the symbol (●) refers to a refractive index curve of the MMA/DS/MAES/Ag GRIN plastic rod with nanoparticles in 1.2×10⁻³ percent by mole, the symbol (♦) refers to a refractive index curve of the MMA/DS/AUPDS/Ag GRIN plastic rod with nanoparticles in 1.2×10⁻³ percent by mole, the symbol (▪) refers to a refractive index curve of the MMA/DS/MAES/Ag GRIN plastic rod with nanoparticles in 1.0×10⁻⁴ percent by mole, and the symbol (▴) refers to a refractive index curve of the MMA/DS/AUPDS/Ag GRIN plastic rod with nanoparticles in 1.0×10⁻⁴ percent by mole. The GRIN plastic rod of the present invention is added with nanoparticles, and the refractive index of the GRIN plastic rod with nanoparticles is more than the same one without nanoparticles, so as to increase the whole refractive index of the plastic rod its NA value.

In a preferred embodiment of the present invention, the optical characteristics of the resultant GRIN plastic rod are shown in TAB. 3:

TABLE 3

The Monomer Composition

| | MMA/MAES/Ag | MMA/DS/AOT/Ag |
|---|---|---|
| Ag (percent by mole) | 1.35 × 10⁻³ | 1.70 × 10⁻⁵ |
| Δn | 0.057 | 0.0071 |
| NA | 0.4133 | 0.1792 |
| A | 0.081 | 0.0253 |
| 2θₘₐₓ | 48.8° | 20.65° |

Δn is the refractive index difference between the center and the periphery of the plastic rod, NA is numeric aperture, A is the absorption of the resultant plastic rod at 410 nm, and θₘₐₓ is a half of the maximum acceptable angle. As shown in TAB. 3, the optical characters of the resultant GRIN plastic rod produced by the present method, such as Δn, NA value, A value and 2θₘₐₓ, all increase, so as to reveal the effect of the GRIN plastic rod.

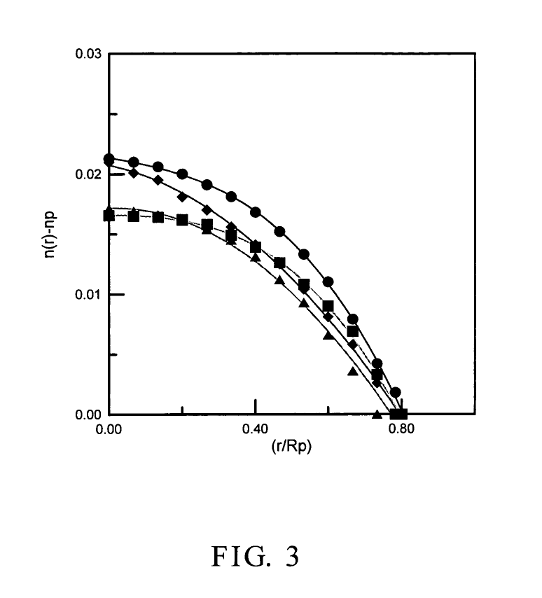

Reference is made to FIG. 3, which shows an image picture transmitted through the GRIN plastic rod according to a preferred embodiment of the present invention, wherein the image is shrunken, reversed and transmitted clearly. Therefore, according to the aforementioned preferred embodiments, one advantage of the method for making a GRIN plastic rod of the present invention is that the surfmer of the present invention is added to introduce nanoparticles into a plastic rod. An oil-phase (hydrophobic) portion of the surfactant can participate a polymerization of organic polymers, and a water-phase (hydrophilic) portion thereof can increase an amount of the nanoparticles, so as to keep nanoparticles and polymers in a good mutual solubility. Therefore, a problem of the resulting opaque plastic rod caused by introducing nanoparticles can be successfully overcome.

According to the aforementioned preferred embodiments, one advantage of the method for making a GRIN plastic rod of the present invention is that the GRIN plastic rod has a great increase of a difference of refractive index and a NA value greatly due to containing nanoparticles, so as to promote an image transmitting efficiency significantly.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

1. A composition suitable for forming a gradient refractive-index (GRIN) plastic rod, comprising:
at least one monomer;
at least one surfactant monomer (surfmer); and
nanoparticles.

2. The composition suitable for forming the GRIN plastic rod according to claim 1, wherein the monomer is selected from the group consisting of methyl methacrylate (MMA), benzyl methacrylate (BzMA), tetrafluoropyl methacrylate, tetrafluoropyl methacrylate, diphenyl sulfide (DS), bromonaphthalene (BN), benzyl salicylate (BSA), 1,4-dibromobenzene, triphenyl phosphate (TPP) and any combination thereof.

3. The composition suitable for forming the GRIN plastic rod according to claim 1, wherein the surfmer is selected from the group consisting of compounds of formulas (I) to (VI) and any combination thereof: 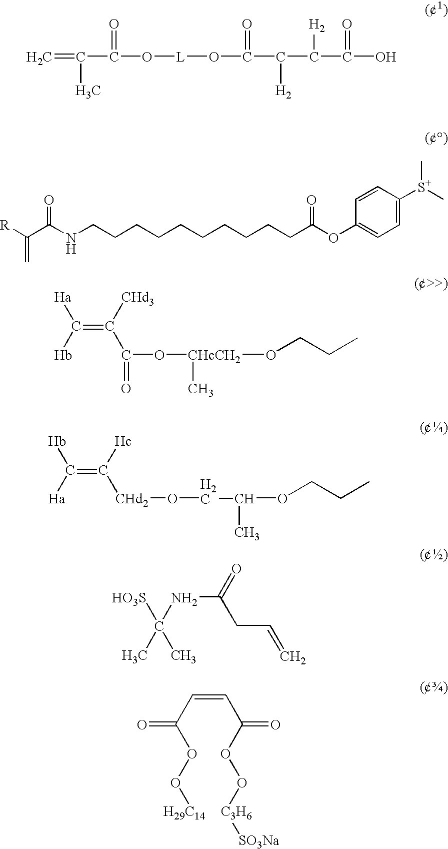
wherein L is a C₂-C₂₀ alkylene group, and R is hydrogen atom or methyl group.

4. The composition suitable for forming the GRIN plastic rod according to claim 1, wherein the nanoparticles are selected from the group consisting of surfmer-stabilized metal nanoparticles, organic polymer nanoparticles and coupler-stabilized metal oxide nanoparticles.

5. The composition suitable for forming the GRIN plastic rod according to claim 1, wherein an amount of the nanoparticles is in a range of 1×10⁻⁵ to 2×10⁻³ percent by mole.

6. A method for making a GRIN plastic rod, comprising:
providing a mixing solution having at least one monomer, at least one surfmer and nanoparticles;
performing a pre-polymerization, wherein the mixing solution is poured into a glass tube, followed by adding an initiator into the mixing solution, and pre-polymerizing the monomer and the surfmer to a prepolymer by a centrifugation; and
performing a diffusing polymerization, wherein the prepolymer is heated to form the GRIN plastic rod.

7. The method for making the GRIN plastic rod according to claim 6, wherein a method for making the nanoparticles comprises:
forming a plurality of reverse micellar systems, wherein two solutions are respectively added into another mixing solution containing the surfmer and the monomer at 25° C., and each of the two solutions and the mixing solution are in a weight ratio of 1/1, whereby forming the reverse micellar systems; and
performing a redox reaction, wherein the reverse micellar systems collide with each other, diffuse and reagglutinate, for keeping the two solutions to be subjected to the redox reaction in the reverse micellar systems, whereby forming the mixing solution containing the nanoparticles.

8. The method for making the GRIN plastic rod according to claim 7, wherein the surfmer is selected from the group consisting of compounds of formulas (I) to (VI) and any combination thereof: 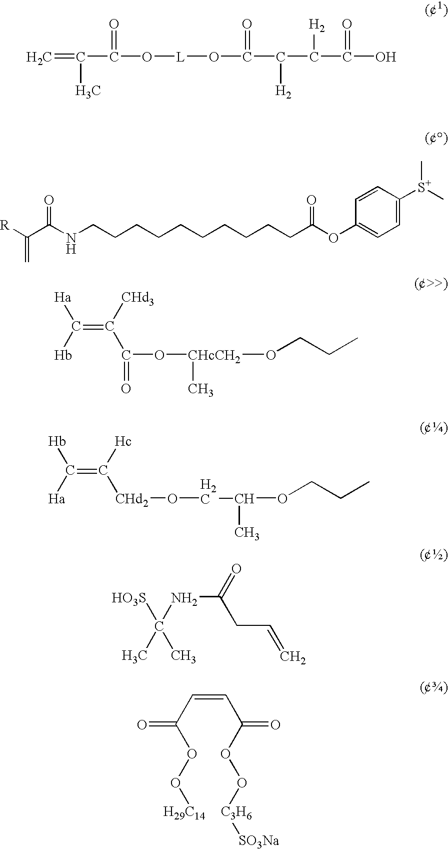
wherein L is a C₂-C₂₀ alkylene group, and R is hydrogen atom or methyl group.

9. The method for making the GRIN plastic rod according to claim 7, wherein the two solutions are a nitrate solution and a reductant solution.

10. The method for making the GRIN plastic rod according to claim 9, wherein the nitrate solution is silver nitrate (AgNO₃) solution.

11. The method for making the GRIN plastic rod according to claim 9, wherein the reductant solution is sodium borohydride (NaBH₄) solution.

12. The method for making the GRIN plastic rod according to claim 7, wherein during the redox reaction, an ultrasonication is employed for 1 hour to keep the reverse micellar systems to collide with each other, diffuse and reagglutinate, whereby carrying out the redox reaction.

13. The method for making the GRIN plastic rod according to claim 6, wherein an amount of the nanoparticles is in a range of 1×10⁻⁵ to 2×10⁻³ percent by mole.

14. The method for making the GRIN plastic rod according to claim 6, wherein the monomer is selected from the group consisting of MMA, BzMA, tetrafluoropyl methacrylate, tetrafluoropyl methacrylate, DS, BN, BSA, 1,4-dibromobenzene, TPP and any combination thereof.

15. The method for making the GRIN plastic rod according to claim 14, wherein the monomer is a mixture of MMA and DS in a ratio of 2/1 to 5/1 by weight.

16. The method for making the GRIN plastic rod according to claim 14, wherein the monomer is a mixture of MMA and BzMA in a ratio of 3/1 by weight.

17. The method for making the GRIN plastic rod according to claim 14, wherein the monomer is a mixture of MMA and BN in a ratio of 3/1 to 4/1 by weight.

18. The method for making the GRIN plastic rod according to claim 6, wherein the initiator is azobisisobutyronitrile (AIBN) in a percent of 0.1 to 0.5 by weight.

19. The method for making the GRIN plastic rod according to claim 6, wherein the initiator is AIBN in a percent of 0.2 by weight.

20. The method for making the GRIN plastic rod according to claim 6, wherein during the step of adding the initiator, an ultrasonication is employed to vibrate the initiator and the mixing solution for 5 minutes.

21. The method for making the GRIN plastic rod according to claim 6, wherein the diffusing polymerization is employed to keep the glass tube to rotate horizontally for 1 hour to 5 hours in a rotation rate of 100 rounds per minute (rpm) to 1000 rpm at 35° C. to 80° C.

22. The method for making the GRIN plastic rod according to claim 6, wherein the diffusing polymerization is employed to keep the glass tube to rotate horizontally for 1 hour to 3 hours in a rotation rate of 200 rpm to 400 rpm at 55° C. to 60° C.

23. The method for making the GRIN plastic rod according to claim 6, wherein the diffusing polymerization is employed to keep the glass tube rotating in a angle of about 1° to 30 to a level for 1 hour to 3 hours in a rotation rate of 200 rpm to 400 rpm at 55° C. to 60° C.

24. The method for making the GRIN plastic rod according to claim 6, wherein during the diffusing polymerization, the prepolymer is reacted for 8 hours to 10 hours at 60° C. to 65° C.

25. A method for making the GRIN plastic rod, comprising:
providing a mixing solution having at least one monomer, at least one surfmer and nanoparticles;
performing a swelling reaction, wherein the mixing solution is poured into a plastic tube and reacted for a predetermined time, for prepolymerizing the monomer and the surfmer to a prepolymer; and
performing a polymerization, wherein the prepolymer is heated to form the GRIN plastic rod.

26. The method for making the GRIN plastic rod according to claim 25, wherein the surfmer is selected from the group consisting of compounds of formulas (I) to (VI) and any combination thereof: 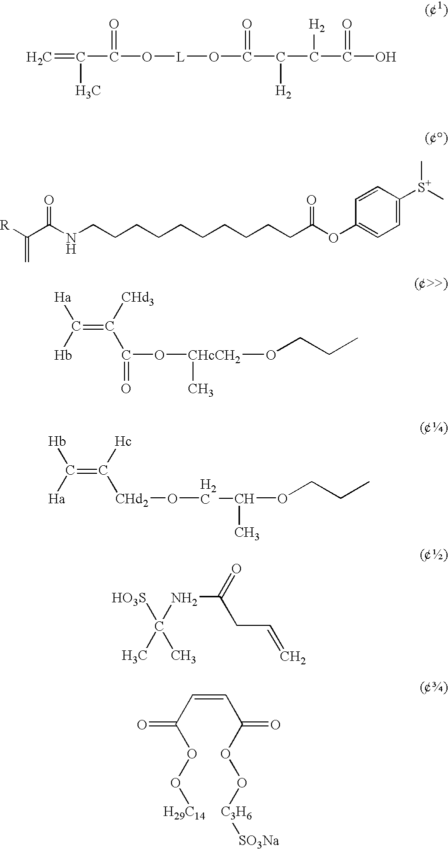
wherein L is a C₂-C₂₀ alkylene group, and R is hydrogen atom or methyl group.

27. The method for making the GRIN plastic rod according to claim 25, wherein the nanoparticles are selected from the group consisting of surfmer-stabilized metal nanoparticles, organic polymer nanoparticles and coupler-stabilized metal oxide nanoparticles.

28. The method for making the GRIN plastic rod according to claim 25, wherein an amount of the nanoparticles is in a range of 1×10⁻⁵ to 2×10⁻³ percent by mole.

29. The method for making the GRIN plastic rod according to claim 25, wherein the monomer is selected from the group consisting of MMA, BzMA, tetrafluoropyl methacrylate, tetrafluoropyl methacrylate, DS, BN, BSA, 1,4-dibromobenzene, TPP and any combination thereof.

30. The method for making the GRIN plastic rod according to claim 29, wherein the monomer is a mixture of MMA and DS in a ratio of 2/1 to 5/1 by weight.

31. The method for making the GRIN plastic rod according to claim 29, wherein the monomer is a mixture of MMA and BzMA in a ratio of 3/1 by weight.

32. The method for making the GRIN plastic rod according to claim 29, wherein the monomer is a mixture of MMA and BN in a ratio of 3/1 to 4/1 by weight.

33. The method for making the GRIN plastic rod according to claim 25, wherein the swelling reaction is employed at 55° C. to 65° C.

34. The method for making the GRIN plastic rod according to claim 25, wherein the predetermined time is in a range of 10 hours to 40 hours.

35. The method for making the GRIN plastic rod according to claim 25, wherein during the step of performing the polymerization, the prepolymer is reacted for 10 hours to 40 hours at 40° C. to 80° C.

36. A method for making the GRIN plastic rod, comprising:
providing a mixing solution having at least one monomer, at least one surfmer and nanoparticles; and
performing a multiplayer co-extruding process, which utilizes a plurality of multiplayer extruding pipes with different calibers covered concentrically, so as to keep concentrations of the monomer and the nanoparticles in the mixing solution decreased progressively from a center to an outside, and while co-extruding the multiplayer extruding pipes, an ultra-violet light is irradiated to the mixing solution for carrying out a polymerization, whereby forming the GRIN plastic rod.

37. The method for making the GRIN plastic rod according to claim 36, wherein the surfmer is selected from the group consisting of compounds of formulas (I) to (VI) and any combination thereof: 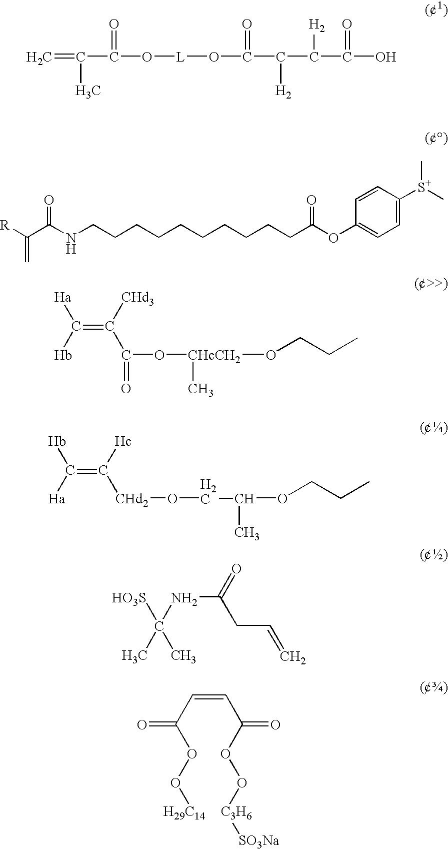
wherein L is a C₂-C₂₀ alkylene group, and R is hydrogen atom or methyl group.

38. The method for making the GRIN plastic rod according to claim 36, wherein the nanoparticles are selected from the group consisting of surfmer-stabilized metal nanoparticles, organic polymer nanoparticles and coupler-stabilized metal oxide nanoparticles.

39. The method for making the GRIN plastic rod according to claim 36, wherein an amount of the nanoparticles is in a range of 1×10⁻⁵ to 2×10⁻³ percent by mole.

40. The method for making the GRIN plastic rod according to claim 36, wherein the monomer is selected from the group consisting of MMA, BzMA, tetrafluoropyl methacrylate, tetrafluoropyl methacrylate, DS, BN, BSA, 1,4-dibromobenzene, TPP and any combination thereof.

41. The method for making the GRIN plastic rod according to claim 40, wherein the monomer is a mixture of MMA and DS in a ratio of 2/1 to 5/1 by weight.

42. The method for making the GRIN plastic rod according to claim 40, wherein the monomer is a mixture of MMA and BzMA in a ratio of 3/1 by weight.

43. The method for making the GRIN plastic rod according to claim 40, wherein the monomer is a mixture of MMA and BN in a ratio of 3/1 to 4/1 by weight.

44. The method for making the GRIN plastic rod according to claim 36, wherein during carrying out the polymerization, a winding machine is employed to control a winding speed, whereby producing the GRIN plastic rod continuously.
